(19) United States
(12) Patent Application Publication
(10) Pub. No.: US 2024/0013239 A1
(43) Pub. Date: Jan. 11, 2024

(54) CONSUMER BEHAVIOR PREDICTION METHOD, CONSUMER BEHAVIOR PREDICTION DEVICE, AND CONSUMER BEHAVIOR PREDICTION PROGRAM

(71) Applicant: NIPPON TELEGRAPH AND TELEPHONE CORPORATION, Tokyo (JP)

(72) Inventors: Mizuki NAGANO, Tokyo (JP); Yusuke IJIMA, Tokyo (JP)

(73) Assignee: NIPPON TELEGRAPH AND TELEPHONE CORPORATION, Tokyo (JP)

(21) Appl. No.: 18/038,466

(22) PCT Filed: Nov. 26, 2020
(86) PCT No.: PCT/JP2020/044090

§ 371 Date: May 24, 2023

(51) Int. Cl. G06Q 30/0202; G10L 25/63

(52) U.S. Cl. CPC G06Q 30/0202; G10L 25/63

(57) ABSTRACT

An acquisition unit acquires a voice feature quantity vector representing a feature of input voice data, an emotion expression vector representing a customer's emotion corresponding to the voice data, and a purchase intention vector representing a purchase intention of the customer corresponding to the voice data. A learning unit generates, by learning, a purchase intention estimation model for estimating a purchase intention of a customer corresponding to the voice data by using the voice feature quantity vector, the emotion expression vector, and the purchase intention vector.

### TECHNICAL FIELD

The present invention relates to a consumer behavior prediction method, a consumer behavior prediction device, and a consumer behavior prediction program.

### BACKGROUND ART

Conventionally, in marketing or consumer behavior research, a purchasing behavior model called a pleasure-arousal-dominance (PAD) model is known (refer to Non Patent Literature 1 to 9). In the PAD model, when a consumer enters a store, a behavior of “approaching” indicating a high purchase intention or a behavior of “avoiding” indicating a low purchase intention occurs due to emotions generated by external stimuli such as a congestion situation of the store or a product arrangement, and it is determined whether or not the consumer will shift to the purchasing behavior. Here, the emotions are represented in the three dimensions of “Pleasure” indicating another suggestion, “Arousal” indicating an excited state, and “Dominance” indicating one's own influence on the situation. In this manner, it can be said that the purchasing behavior can be influenced by a change of the consumer's emotions due to external stimuli using the PAD model.

Note that Non Patent Literature 4 describes OpenSMILE which is a voice feature quantity extraction tool. In addition, Non Patent Literature 5 describes a neural network. Furthermore, Non Patent Literature 6 and 7 describe dimensions of emotion expression. In addition, Non Patent Literature 8 describes a purchase intention. In addition, Non Patent Literature 9 describes classification of products.

### CITATION LIST

### Non Patent Literature

Non Patent Literature 1: Iris Bakker, et al., “Pleasure, Arousal, Dominance: Mehrabian and Russell revisited”, Curr Psychol, 2014
Non Patent Literature 2: “Empirical Study on Emotion and Cognitive Advantage in Advertising Effect Model”, Yuichi Mitsui, Management Research=The business review, 2017
Non Patent Literature 3: Donovan, R. J., Rossiter, J. R., Marcoolyn, G., and Nesdale, A. “Store atmosphere and purchasing behavior”, Journal of Retailing, Vol. 70, No. 3, 1994, pp. 283-294
Non Patent Literature 4: F. Eyben, M. Wollmer, and B. Schuller, “OpenSMILE: the Munich versatile and fast open-source audio feature extractor”, in ACM International conference on Multimedia (MMd 2010), Florence, Italy, 2010, pp. 1459-1462
Non Patent Literature 5: Han, K., Yu, D. and Tashev, I., “Speech Emotion Recognition Using Deep Neural Network and Extreme Learning Machine”, Proc. of INTERSPEECH, 2014, pp. 223-227
Non Patent Literature 6: J. Russell, “A circumplex model of affect”, Journal of Personality and Social Psychology, vol. 39, no. 6, 1980, pp. 1161-1178
Non Patent Literature 7: S. Parthasarathy, C. Busso, “Jointly Predicting Arousal, Valence and Dominance with Multi-Task Learning”, INTERSPEECH 2017, 2017, pp. 1103-1107
Non Patent Literature 8: C. G. Ding, C. H. Lin, “How does background music tempo work for online shopping?”, Electronic Commerce Research and Applications, Vol. 11, No. 3, 2012, pp. 299-307
Non Patent Literature 9: H. Assael, “Consumer behavior and marketing action”, Kent Publishing Company, 1981

### SUMMARY OF INVENTION

### Technical Problem

However, in the related art, it is difficult to estimate the purchase intention generated by the voice stimulus. For example, in experiments using a PAD model, various studies have been conducted using, as external stimuli, a store congestion situation, a product arrangement, in-store BGM, and the like, and it has been confirmed that emotions generated by external stimuli affect purchasing behavior. On the other hand, voice stimulus has hardly been studied. In addition, in experiments using the PAD model, studies have been conducted based on a small number of feature quantities perceivable by humans, such as whether the tempo of the BGM is clearly fast or slow. However, information actually acquired from the five senses as external stimuli by humans is not only clearly perceptible information, and whether or not information other than the feature quantity under consideration or a combination with other information affects the purchasing behavior has not been studied.

The present invention has been made in view of the above, and an object thereof is to estimate a purchase intention generated by a voice stimulus.

### Solution to Problem

In order to solve the above problem and achieve an object, according to the present invention, there is provided a consumer behavior prediction method executed by a consumer behavior prediction device, the method including: an acquisition process of acquiring a voice feature quantity vector representing a feature of input voice data, an emotion expression vector representing a customer's emotion corresponding to the voice data, and a purchase intention vector representing a purchase intention of the customer corresponding to the voice data; and a learning process of generating, by learning, a model for estimating a purchase intention of a customer corresponding to the voice data by using the voice feature quantity vector, the emotion expression vector, and the purchase intention vector.

### Advantageous Effects of Invention

According to the present invention, it is possible to estimate a purchase intention generated by a voice stimulus.

### BRIEF DESCRIPTION OF DRAWINGS

FIG. 1 is a schematic diagram illustrating a schematic configuration of a consumer behavior prediction device.

FIG. 2 is a diagram for explaining processing of the consumer behavior prediction device of a first embodiment.

FIG. 3 is a diagram for explaining the processing of the consumer behavior prediction device of the first embodiment.

FIG. 4 is a diagram for explaining processing of the consumer behavior prediction device of the first embodiment.

FIG. 5 is a flowchart illustrating a consumer behavior prediction processing procedure.

FIG. 6 is a flowchart illustrating the consumer behavior prediction processing procedure.

FIG. 7 is a diagram for explaining processing of a consumer behavior prediction device of a second embodiment.

FIG. 8 is a diagram for explaining the processing of the consumer behavior prediction device of the second embodiment.

FIG. 9 is a diagram for explaining the processing of the consumer behavior prediction device of the second embodiment.

FIG. 10 is a diagram for explaining processing of a consumer behavior prediction device of a third embodiment.

FIG. 11 is a diagram for explaining the processing of the consumer behavior prediction device of the third embodiment.

FIG. 12 is a diagram for explaining processing of a consumer behavior prediction device of a fourth embodiment.

FIG. 13 is a diagram for explaining the processing of the consumer behavior prediction device of the fourth embodiment.

FIG. 14 is a diagram illustrating a computer that executes a consumer behavior prediction program.

### DESCRIPTION OF EMBODIMENTS

Hereinafter, an embodiment of the present invention will be described in detail with reference to the drawings.

Note that the present invention is not limited by this embodiment. Further, in the description of the drawings, the same portions are denoted by the same reference numerals.

[Configuration of Consumer Behavior Prediction Device]

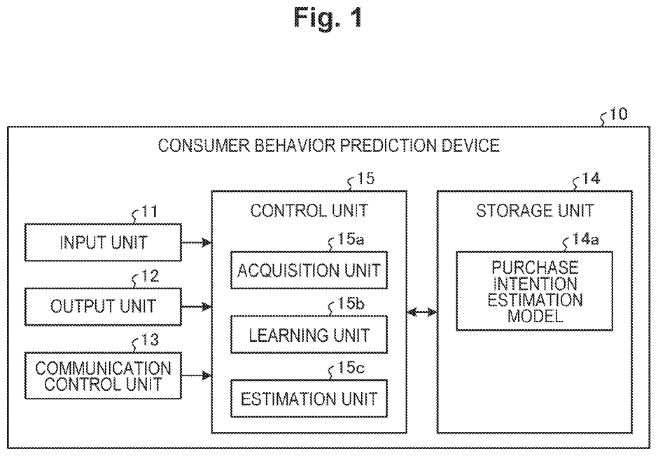

FIG. 1 is a schematic diagram illustrating a schematic configuration of a consumer behavior prediction device. As illustrated in FIG. 1, a consumer behavior prediction device 10 is realized by a general-purpose computer such as a personal computer, and includes an input unit 11, an output unit 12, a communication control unit 13, a storage unit 14, and a control unit 15.

The input unit 11 is realized by using an input device such as a keyboard and a mouse, and inputs various kinds of instruction information such as a processing start to the control unit 15 in response to input operations of an operator. The output unit 12 is realized by a display device such as a liquid crystal display, a printing device such as a printer, an information communication device, or the like.

The communication control unit 13 is realized by a network interface card (NIC) or the like and controls communication between an external device such as a server and the control unit 15 via a network. For example, the communication control unit 13 controls communication between the control unit 15 and a management device or the like that manages voice data of a consumer behavior prediction target, emotion expression data corresponding to the voice data, and the like.

The storage unit 14 is realized by a semiconductor memory element such as a random access memory (RAM) or a flash memory or a storage device such as a hard disk or an optical disc. In the present embodiment, the storage unit 14 stores, for example, voice data used for consumer behavior prediction processing to be described later, an emotion expression vector corresponding to the voice data, a purchase intention estimation model 14a generated in the consumer behavior prediction processing, and the like. Note that the storage unit 14 may be configured to communicate with the control unit 15 via the communication control unit 13.

The control unit 15 is realized by using a central processing unit (CPU), a network processor (NP), a field programmable gate array (FPGA), or the like, and executes a processing program stored in a memory. Thereby, the control unit 15 functions as an acquisition unit 15a, a learning unit 15b, and an estimation unit 15c as illustrated in FIG. 1. Note that each of these functional units may be implemented in different pieces of hardware. For example, the learning unit 15b and the estimation unit 15c may be implemented in different hardware. Moreover, the control unit 15 may include other functional units.

### First Embodiment

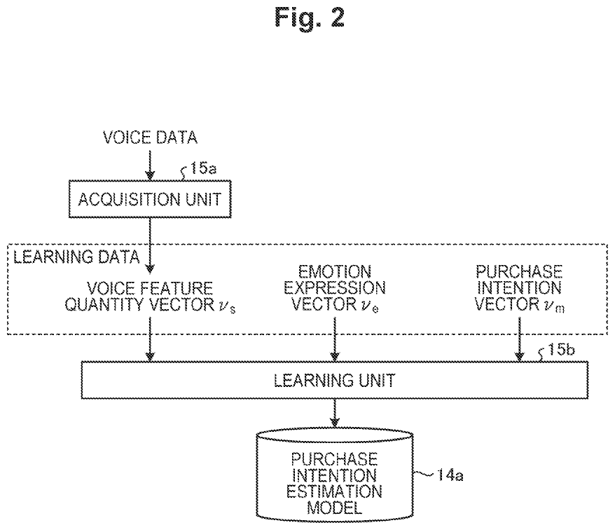

FIGS. 2 to 4 are diagrams for explaining the processing of the consumer behavior prediction device of a first embodiment. In the consumer behavior prediction device 10 according to the first embodiment, as illustrated in FIG. 2, the acquisition unit 15a acquires a voice feature quantity vector Vₛ representing a feature of input voice data, an emotion expression vector Vₑ representing a customer's emotion corresponding to the voice data, and a purchase intention vector Vₘ representing a purchase intention of the customer corresponding to the voice data.

For example, the acquisition unit 15a acquires voice data to be processed in the consumer behavior prediction processing described later via the input unit 11 or from a management device or the like that manages the voice data via the communication control unit 13. Here, the voice data is recording data of a voice stimulus that the customer hears when purchasing a product as an external stimulus of the customer. The utterance content or the number of sentences of the voice data, the number of speakers, the gender, and the like are not particularly limited.

In addition, the acquisition unit 15a extracts the voice feature quantity vector Vₛ representing voice features such as the height (F0) or power of the voice, speaking speed, spectrum and the like from the voice data. For example, the acquisition unit 15a performs signal processing such as Fourier transform for each frame, for example, and outputs a numerical value as the voice feature quantity vector Vₛ. Alternatively, the acquisition unit 15a extracts the voice feature quantity vector Vₛ using a voice feature quantity extraction tool such as OpenSMILE (refer to Non Patent Literature 4).

Furthermore, the acquisition unit 15a acquires the emotion expression vector Vₑ corresponding to the voice data. Here, the emotion expression vector Vₑ is subjective evaluation data representing emotions when a customer hears voice data, and is, for example, n-dimensional (n≥1) numerical values. The emotion expression vector Vₑ may include other emotion dimensions (refer to Non Patent Literature 6 and 7) of three-dimensional emotions of pleasure, arousal, and dominance, which are measures of PAD. In the present embodiment, the emotion expression vector Vₑ is acquired by obtaining seven levels of answers for each dimension through a customer survey in advance, and is stored in the storage unit of the voice data management device in association with voice data, for example.

It is assumed that the acquisition unit 15a acquires one emotion expression vector Vₑ having n dimensions corresponding to one piece of voice data. Furthermore, in a case where a plurality of customers performs subjective evaluation on one piece of voice data, the acquisition unit 15a acquires an average thereof as the emotion expression vector Vₑ.

In addition, the acquisition unit 15a acquires the purchase intention vector Vₘ corresponding to the voice data. Here, the purchase intention vector Vₘ, is data representing the purchase intention when the customer hears the voice data, and is, for example, a numerical value representing “how much the customer wants to buy” in seven levels. The purchase intention vector Vₘ is not necessarily a numerical value representing a level, and for example, whether or not a customer has actually purchased a product may be obtained from a purchase log or the like stored as a binary value. As a result, it is possible to easily provide the purchase intention vectors Vₘ that are necessary for learning the purchase intention estimation model in a large amount.

Furthermore, in the present embodiment, similarly to the emotion expression vector Vₑ, the purchase intention vector Vₘ is acquired in advance through a customer survey, and is stored in the storage unit of the voice data management device in association with the voice data, for example.

It is assumed that the acquisition unit 15a acquires one purchase intention vector Vₘ corresponding to one piece of voice data. In addition, in a case where a plurality of customers evaluates the purchase intention for one piece of voice data, the acquisition unit 15a acquires an average thereof as the purchase intention vector Vₘ.

In addition, the purchase intention vector Vₘ is information for the same voice data for the same customer as for the emotion expression vector Vₑ. That is, as illustrated in FIG. 2, the acquisition unit 15a acquires the voice feature quantity vector Vₛ, the emotion expression vector Vₑ, and the purchase intention vector Vₘ as a set for one piece of voice data.

As illustrated in FIG. 2, the learning unit 15b uses the voice feature quantity vector Vₛ, the emotion expression vector Vₑ, and the purchase intention vector Vₘ to generate, by learning, the purchase intention estimation model 14a for estimating the purchase intention of the customer corresponding to the voice data. In addition, the learning unit 15b stores the generated purchase intention estimation model 14a in the storage unit 14.

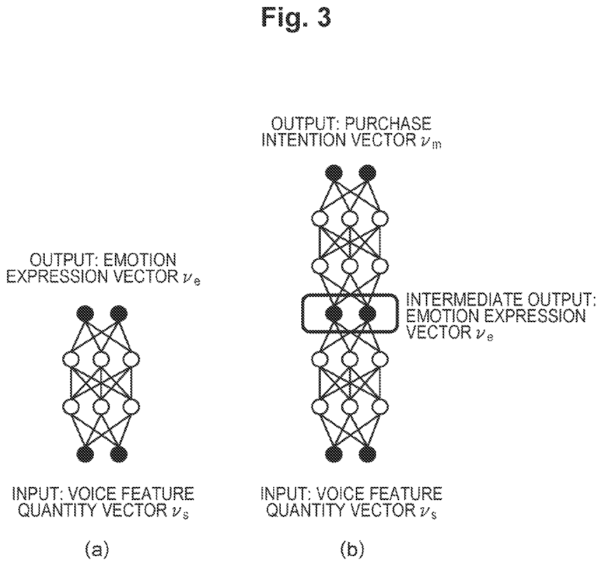

Here, as illustrated in FIG. 3(a), a neural network that generates, by learning, a model that outputs the emotion expression vector Vₑ using the voice feature quantity vector Vₛ as an input is conventionally known (refer to Non Patent Literature 7).

In the present embodiment, as illustrated in FIG. 3(b), the learning unit 15b generates the purchase intention estimation model 14a by learning by using the emotion expression vector Vₑ as the intermediate output. Specifically, the learning unit 15b generates, by learning, a model that outputs a vector Vₒ=[Vₑ, Vₘ] obtained by integrating the emotion expression vector Vₑ and the purchase intention vector Vₘ. That is, the learning unit 15b uses the voice feature quantity vector Vₛ to generate a model that minimizes an error between the emotion expression vector Vₑ and the purchase intention vector Vₘ and the teacher data.

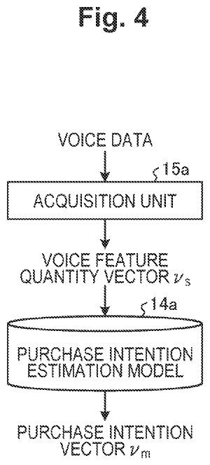

As illustrated in FIG. 4, the estimation unit 15c estimates the purchase intention vector Vₘ corresponding to the input voice data using the generated purchase intention estimation model 14a. Specifically, the estimation unit 15c inputs the voice feature vector Vₛ acquired by the acquisition unit 15a from the input voice data to the generated purchase intention estimation model 14a, and obtains the output purchase intention vector Vₘ. As a result, the estimation unit 15c estimates the customer's purchase intention generated by the voice stimulus.

Note that, instead of the purchase intention vector Vₘ of the present embodiment, a vector representing any consumer behavior other than the purchase behavior may be applied.

[Consumer Behavior Prediction Processing]

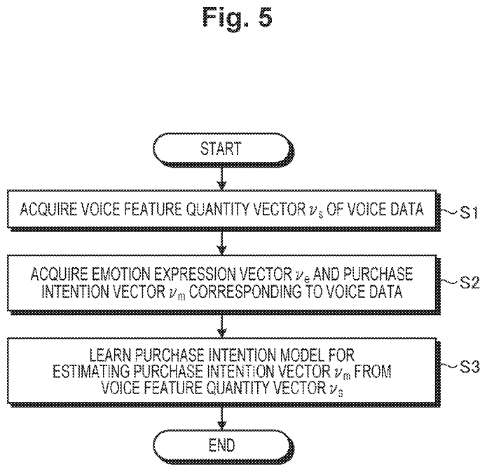

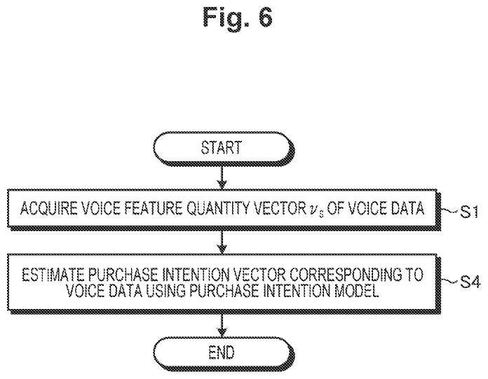

Next, consumer behavior prediction processing by the consumer behavior prediction device 10 will be described. FIGS. 5 and 6 are flowcharts illustrating the consumer behavior prediction processing procedure. The consumer behavior prediction processing of the present embodiment includes learning processing and estimation processing. First, FIG. 5 illustrates a learning processing procedure. The flowchart of FIG. 5 is started, for example, at a timing when an operation for instructing a start of learning processing is input.

First, the acquisition unit 15a acquires the voice feature quantity vector Vₘ representing a voice feature from voice data input as an external stimulus (step S1). Furthermore, the acquisition unit 15a acquires the emotion expression vector Vₑ and the purchase intention vector Vₘ corresponding to the voice data (step S2).

Next, the learning unit 15b uses the voice feature quantity vector Vₛ, the emotion expression vector Vₑ, and the purchase intention vector Vₘ to generate, by learning, the purchase intention estimation model 14a for estimating the purchase intention of the customer corresponding to the voice data (step S3). For example, the learning unit 15b learns the purchase intention estimation model 14a by using the emotion expression vector Vₑ as the intermediate output. Thereby, the series of learning processing ends.

Next, FIG. 6 illustrates an estimation processing procedure. The flowchart of FIG. 6 is started, for example, at a timing when an operation for instructing a start of estimation processing is input.

First, the acquisition unit 15a acquires the voice feature quantity vector Vₘ representing a voice feature from voice data to be estimated (step S1).

Next, the estimation unit 15c inputs the voice feature vector Vₛ to the generated purchase intention estimation model 14a, and estimates the purchase intention vector Vₘ (step S4). The estimation unit 15c estimates the customer's purchase intention from the estimated purchase intention vector Vₘ. Thereby, the series of estimation processing ends.

### Second Embodiment

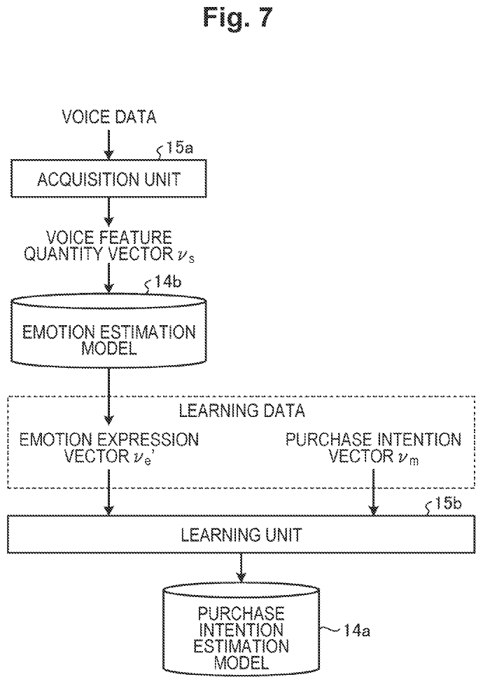

FIGS. 7 to 9 are diagrams for explaining the processing of a consumer behavior prediction device of a second embodiment. Hereinafter, only differences from the consumer behavior prediction processing of the consumer behavior prediction device 10 of the above first embodiment will be described, and description of common points will be omitted.

In the consumer behavior prediction device 10 of the above embodiment, as illustrated in FIG. 2, the learning unit 15b uses the voice feature quantity vector Vₛ, the emotion expression vector Vₑ, and the purchase intention vector Vₘ to generate, by learning, the purchase intention estimation model 14a. In this case, the learning unit 15b sets a vector Vₒ obtained by integrating the emotion expression vector Vₑ and the purchase intention vector Vₘ as a learning target.

On the other hand, in the consumer behavior prediction device 10 according to the second embodiment, as illustrated in FIG. 7, the acquisition unit 15a uses the emotion estimation model 14b that outputs an emotion expression vector Vₑ′ corresponding to the voice feature quantity vector Vₛ. The emotion estimation model 14b in this case may be constructed to estimate emotions from voice data by a known technique (refer to Non Patent Literature 7).

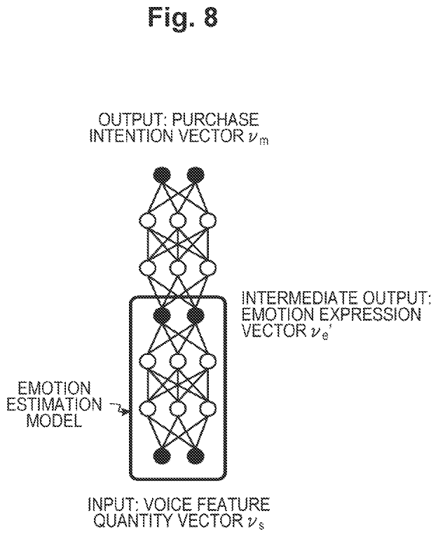

As a result, it is possible to easily provide a large amount of emotion expression vectors Vₛ necessary for learning the purchase intention estimation model 14a without depending on a customer survey. Furthermore, the learning unit 15b can input the emotion expression vector Vₑ′ output from the emotion estimation model 14b and learn the purchase intention vector Vₘ as an independent target. That is, as illustrated in FIG. 8, the learning unit 15b generates a model that minimizes an error between the purchase intention vector Vₘ and the teacher data by using the emotion expression vector Vₑ′ output from the emotion estimation model 14b learned in advance.

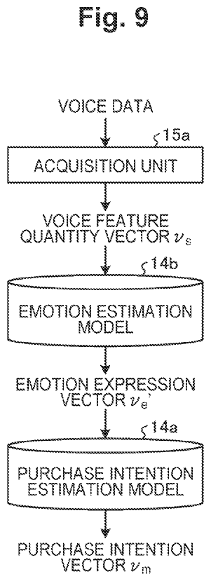

In this case, as illustrated in FIG. 9, the estimation unit 15c inputs the voice feature quantity vector Vₛ acquired by the acquisition unit 15a to the emotion estimation model 14b to acquire the emotion expression vector Vₑ′, and inputs the emotion expression vector Vₑ′ to the purchase intention estimation model 14a generated by the learning unit 15b. As a result, the estimation unit 15c obtains the purchase intention vector Vₘ estimated from the voice stimulus.

### Third Embodiment

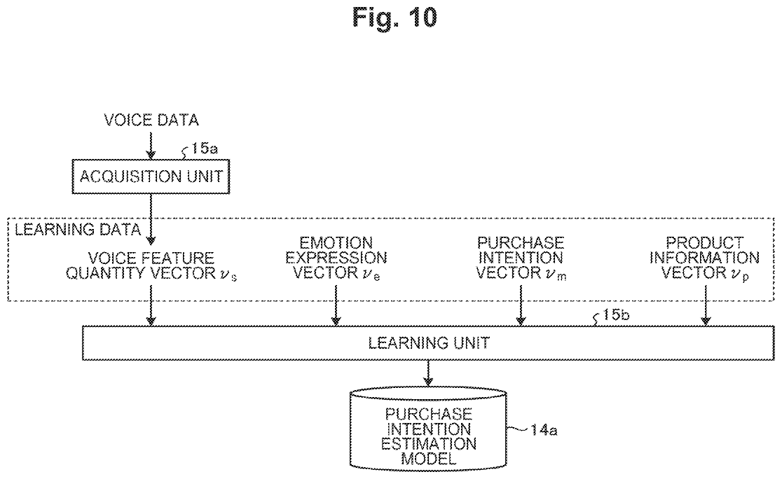

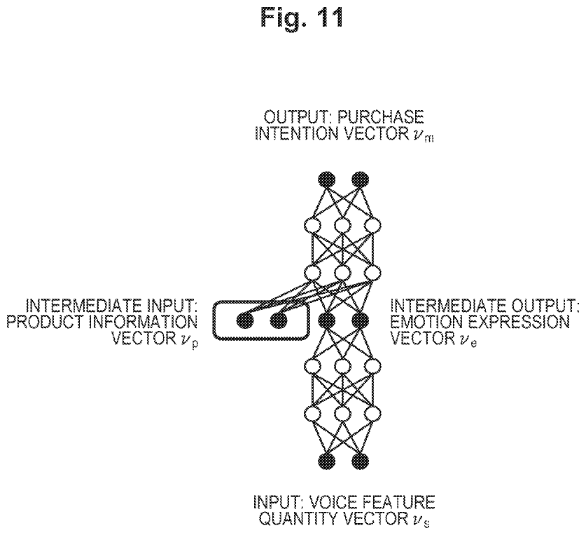

FIGS. 10 and 11 are diagrams for explaining the processing of a consumer behavior prediction device of a third embodiment. In the consumer behavior prediction device 10 of the third embodiment, as illustrated in FIG. 10, the acquisition unit 15a further acquires a product information vector Vₚ representing information associated with a product corresponding to voice data.

Here, the product information vector Vp is information representing a classification of a product expressed numerically with a real numerical value, a 1-hot vector, or the like, and is, for example, either an entertainment product or a practical product (refer to Non Patent Literature 8). Alternatively, the classification of the product may be a classification in terms of a level of involvement with the product and an inter-brand perception difference (refer to Non Patent Literature 9). In addition, as the product information vector Vₚ, a price, a sales period, or the like of a product may be used.

In this case, the learning unit 15b generates the purchase intention estimation model 14a by learning using the product information vector Vₚ in addition to the voice feature quantity vector Vₛ, the emotion expression vector VW, and the purchase intention vector Vₘ. Specifically, as illustrated in FIG. 11, the learning unit 15b generates the purchase intention estimation model 14a in consideration of the product information by learning by using the product information vector Vₚ as an intermediate input and the emotion expression vector Vₑ as an intermediate output.

Furthermore, the estimation unit 15c receives the input of the voice feature quantity vector Vₛ and the product information vector Vₚ, and inputs the input to the purchase intention estimation model 14a generated by the learning unit 15b, thereby obtaining the purchase intention vector Vₘ estimated from the voice stimulus.

As a result, the consumer behavior prediction device 10 can estimate the purchase intention of different customers depending on products even in the same emotional state.

### Fourth Embodiment

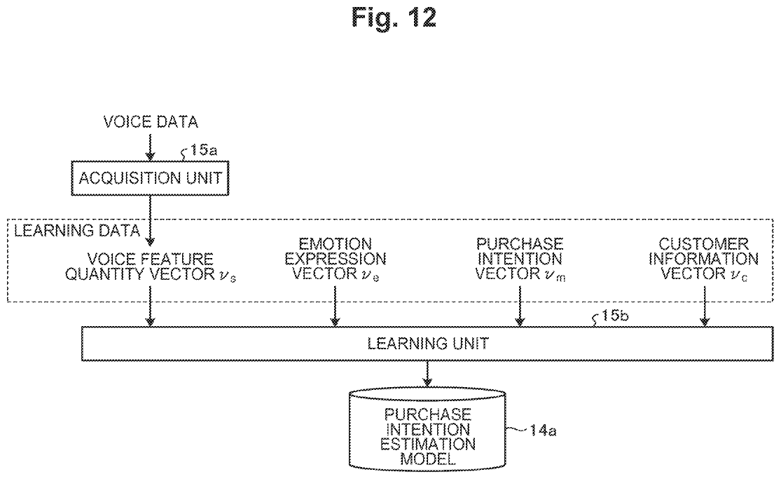

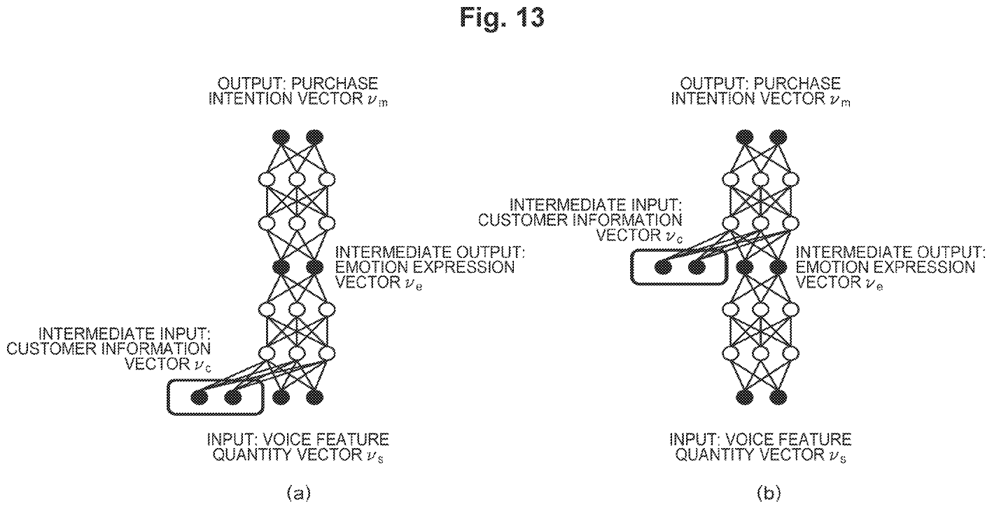

FIGS. 12 and 13 are diagrams for explaining the processing of a consumer behavior prediction device of a fourth embodiment. In the consumer behavior prediction device 10 according to the fourth embodiment, as illustrated in FIG. 12, the acquisition unit 15a further acquires a customer information vector V_{c} representing attributes of a customer corresponding to voice data.

Here, the customer information vector Vc is information representing attributes such as gender, age, and place of residence of the customer expressed numerically with a real numerical value, a 1-hot vector, or the like, and is information registered in advance.

Note that, in the present embodiment, unlike the first embodiment described above, in a case where evaluation values of the emotion expression vectors Vₑ by customers with different customer information vectors Vc are different, the emotion expression vectors Vₑ corresponding to the same voice data are handled as a plurality of sets as they are. In a case where the customer information vector V_{c} has different evaluation values of the emotion expression vectors Vₑ for the same customer, the emotion expression vectors Vₑ corresponding to the same voice data are set as an average value thereof. For example, in a case where there are n types of customer information vectors V_{c} corresponding to the same voice data, the acquisition unit 15a acquires n types of purchase intention vectors Vₘ corresponding to the voice data.

In this case, the learning unit 15b generates the purchase intention estimation model 14a by learning using the customer information vector Vₘ in addition to the voice feature quantity vector Vₛ, the emotion expression vector Vₑ, and the purchase intention vector Vₘ. Specifically, as illustrated in FIGS. 13(a) or 13(b), the learning unit 15b generates the purchase intention estimation model 14a in consideration of the attributes of the customer by learning by using the customer information vector V_{c} as an intermediate input and the emotion expression vector V_{c} as an intermediate output.

Furthermore, the estimation unit 15c receives the input of the voice feature quantity vector Vₛ and the customer information vector V_{c}, and inputs the input to the purchase intention estimation model 14a generated by the learning unit 15b, thereby obtaining the purchase intention vector Vₘ estimated from the voice stimulus.

As a result, the consumer behavior prediction device 10 of the present embodiment can estimate the purchase intention of customers having different emotions generated by the same voice stimulus, or the purchase intention of customers different depending on the gender or the like even when emotions generated by the voice stimulus are the same. For example, for the same voice stimulus, the hearing easiness may be different between a young person and an elderly person. Alternatively, even when the emotions generated by the voice stimulus are the same, for example, in a case where the utterance content is advertisement for men, there is a case where the purchase intention differs depending on the gender. Even in such a case, the consumer behavior prediction device 10 of the present embodiment can estimate the purchase intention in consideration of the attributes of the customer.

[Effect of Consumer Behavior Prediction Processing]

As described above, in the consumer behavior prediction device 10 according to the embodiment, the acquisition unit 15a acquires the voice feature quantity vector Vₛ representing a feature of input voice data, the emotion expression vector Vₑ representing a customer's emotion corresponding to the voice data, and the purchase intention vector Vₘ representing a purchase intention of the customer corresponding to the voice data. The learning unit 15b uses the voice feature quantity vector Vₛ, the emotion expression vector Vₑ, and the purchase intention vector Vₘ to generate, by learning, the purchase intention estimation model 14a for estimating the purchase intention of the customer corresponding to the voice data. Accordingly, it is possible to estimate the purchase intention generated by the voice stimulus.

Furthermore, the learning unit 15b generates a model by learning by using the emotion expression vector as the intermediate output. As a result, the purchase intention estimation model 14a can be learned with high accuracy.

In addition, the estimation unit 15c estimates the purchase intention vector corresponding to the input voice data using the generated purchase intention estimation model 14a. As a result, it is possible to estimate the customer's purchase intention generated by the voice stimulus.

In addition, the acquisition unit 15a uses the emotion estimation model 14b that outputs the emotion expression vector corresponding to the voice feature quantity vector. As a result, it is possible to easily provide a large amount of emotion expression vectors Vₛ necessary for learning the purchase intention estimation model 14a without depending on a customer survey.

In addition, the acquisition unit 15a further acquires a product information vector representing information on a product corresponding to the voice data, and the learning unit 15b generates the model by learning by further using the product information vector. As a result, the consumer behavior prediction device 10 can estimate the purchase intention of different customers depending on products even in the same emotional state.

In addition, the acquisition unit 15a further acquires a customer information vector representing attributes of the customer corresponding to the voice data, and the learning unit 15b generates the model by learning by further using the customer information vector. Accordingly, the consumer behavior prediction device 10 can estimate the purchase intention of customers having different emotions generated by the same voice stimulus, or the purchase intention of customers different depending on the attributes even when emotions generated by the voice stimulus are the same.

[Program]

It is also possible to create a program in which the processing executed by the consumer behavior prediction device 10 according to the above embodiment is described in a language that can be executed by a computer. As an embodiment, the consumer behavior prediction device 10 can be implemented by installing a consumer behavior prediction program for executing the above consumer behavior prediction processing as packaged software or online software in a desired computer. For example, an information processing device can be caused to function as the consumer behavior prediction device 10 by causing the information processing device to execute the above consumer behavior prediction program Further, in addition to this, the information processing apparatus includes mobile communication terminals such as a smartphone, a mobile phone, and a personal handyphone system (PHS), and further includes a slate terminal such as a personal digital assistant (PDA). Further, the functions of the consumer behavior prediction device 10 may be implemented in a cloud server.

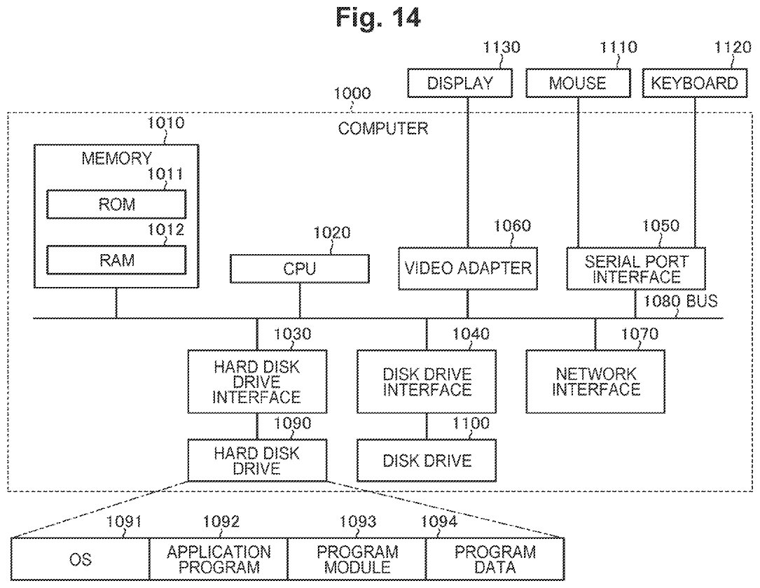

FIG. 14 is a diagram illustrating a computer that executes the consumer behavior prediction program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. A mouse 1051 and a keyboard 1052, for example, are connected to the serial port interface 1050. A display 1061, for example, is connected to the video adapter 1060.

Here, the hard disk drive 1031 stores, for example, an OS 1091, an application program 1092, a program module 1093, and program data 1094. All of the information described in the above embodiment is stored in the hard disk drive 1031 or the memory 1010, for example.

In addition, the consumer behavior prediction program is stored in the hard disk drive 1031 as a program module 1093 in which commands to be executed by the computer 1000, for example, are described. Specifically, the program module 1093 in which all of the processing executed by the consumer behavior prediction device 10 described in the above embodiment is described is stored in the hard disk drive 1031.

Further, data used for information processing performed by the consumer behavior prediction program is stored as program data 1094 in the hard disk drive 1031, for example. Then, the CPU 1020 reads, in the RAM 1012, the program module 1093 and the program data 1094 stored in the hard disk drive 1031 as needed and executes each procedure described above.

Note that the program module 1093 and the program data 1094 related to the consumer behavior prediction program are not limited to being stored in the hard disk drive 1031, and may be stored in, for example, a removable storage medium and read by the CPU 1020 via a disk drive 1041 or the like. Alternatively, the program module 1093 and the program data 1094 related to the consumer behavior prediction program may be stored in another computer connected via a network such as a local area network (LAN) or a wide area network (WAN) and may be read by the CPU 1020 via the network interface 1070.

Although the embodiments to which the invention made by the present inventor is applied have been described above, the present invention is not limited by the description and drawings constituting a part of the disclosure of the present invention according to the present embodiments. In other words, other embodiments, examples, operation techniques, and the like made by those skilled in the art and the like on the basis of the present embodiments are all included in the scope of the present invention.

### REFERENCE SIGNS LIST

10 Consumer behavior prediction device
13 Communication control unit
14 Storage unit
14a Purchase intention estimation model
14b Emotion estimation model
15 Control unit
15a Acquisition unit
15b Learning unit
15c Estimation unit

1. A consumer behavior prediction method executed by a consumer behavior prediction device, the method comprising:
an acquisition process of acquiring a voice feature quantity vector representing a feature of input voice data, an emotion expression vector representing a customer's emotion corresponding to the voice data, and a purchase intention vector representing a purchase intention of the customer corresponding to the voice data; and
a learning process of generating, by learning, a model for estimating a purchase intention of a customer corresponding to the voice data by using the voice feature quantity vector, the emotion expression vector, and the purchase intention vector.

2. The consumer behavior prediction method according to claim 1, wherein the learning process generates the model by learning by using the emotion expression vector as an intermediate output.

3. The consumer behavior prediction method according to claim 1, further comprising: an estimation process of estimating the purchase intention vector corresponding to the input voice data using the generated model.

4. The consumer behavior prediction method according to claim 1, wherein the acquisition process uses a model that outputs the emotion expression vector corresponding to the voice feature quantity vector.

5. The consumer behavior prediction method according to claim 1, wherein
the acquisition process further acquires a product information vector representing information on a product corresponding to the voice data, and
the learning process generates the model by learning by further using the product information vector.

6. The consumer behavior prediction method according to claim 1, wherein
the acquisition process further acquires a customer information vector representing attributes of the customer corresponding to the voice data, and
the learning process generates the model by learning by further using the customer information vector.

7. A consumer behavior prediction device comprising:
a memory; and
a processor coupled to the memory and programmed to execute a process comprising:
acquiring a voice feature quantity vector representing a feature of input voice data, an emotion expression vector representing a customer's emotion corresponding to the voice data, and a purchase intention vector representing a purchase intention of the customer corresponding to the voice data; and
generating, by learning, a model for estimating a purchase intention of a customer corresponding to the voice data by using the voice feature quantity vector, the emotion expression vector, and the purchase intention vector.

8. A non-transitory computer-readable recording medium having stored a consumer behavior prediction program for causing a computer to execute
an acquisition step of acquiring a voice feature quantity vector representing a feature of input voice data, an emotion expression vector representing a customer's emotion corresponding to the voice data, and a purchase intention vector representing a purchase intention of the customer corresponding to the voice data, and
a learning step of generating, by learning, a model for estimating a purchase intention of a customer corresponding to the voice data by using the voice feature quantity vector, the emotion expression vector, and the purchase intention vector.
